(19) United States
(12) Patent Application Publication
(10) Pub. No.: US 2007/0250381 A1
(43) Pub. Date: Oct. 25, 2007

(54) System and method for promoting business activities and charitable contributions

(75) Inventors: William Edward Denk JR., Hanover, PA (US); Ryan Eliot Hamilton, Bear, DE (US); Roy C. Jones, Lynchburg, VA (US)

Correspondence Address: H. JAY SPIEGEL, P. O. BOX 11, MOUNT VERNON, VA, 22121, US

(73) Assignee: William Edward Denk JR.

(21) Appl. No.: 11/406,429

(22) Filed: Apr. 19, 2006

(51) Int. Cl. G06Q 30/00

(52) U.S. Cl. 705/14

(57) ABSTRACT

A system and method promotes business activities and charitable contributions simultaneously. Preferably operated on a global computer network, the invention permits charities to register to receive charitable contributions from businesses that agree to pay a percentage of the proceeds from their business activities to the charities. Consumers access the system via a global computer network and are able to search to determine which charities are involved in the system and their charitable purposes. Consumers may also access the system to determine which businesses are involved and the products and services that may be purchased from them. Consumers purchase products and services from the businesses and the organizer of the system receives payments from the consumers, deducts the percentage to be contributed to the charities, forwards that percentage to the charities, and forwards the remaining funds to the businesses. A banking institution may be directly connected into the system.

### BACKGROUND OF THE INVENTION

The present invention relates to a system and method for promoting business activities and charitable contributions. Promotion of charitable giving is a daunting task for charities and non-profit organizations. As a necessary evil, such organizations must spend, in some cases, a significant percentage of contributions they receive in promoting their activities to the general public to encourage additional giving. The more money that must be spent on promotion of giving, the less money that is available for the purposes of the organization.

At the same time, commercial businesses are always looking for ways to enhance their bottom line. Association with charitable giving gives a commercial enterprise a “white hat” in the minds of typical consumers. As such, it is advantageous for a commercial enterprise to associate itself with the concept of charitable giving.

From the perspective of a consumer, often, comparison shopping is done between competing businesses to ascertain which business will sell a product or service for the lowest possible price without compromising quality of service and of the products themselves. Consumers often ask for discounts on typical retail pricing, and sometimes they are successful in obtaining such discounts. Another way to encourage consumers to patronize a business is to offer customers an unusual incentive to conduct such business, an incentive not offered by competing businesses.

If it were possible to set up a business enterprise in which the combination of achieving competitive pricing for purchases along with satisfying a desire for charitable giving could be combined into a single scenario, this would be advantageous for a business, for a charity, and for consumers. It is with this thought in mind that the present invention was developed.

### SUMMARY OF THE INVENTION

The present invention relates to a system and method for promoting business activities and charitable contributions, all at the same time. The present invention includes the following interrelated objects, aspects and features:

(1) From the perspective of a charitable or non-profit organization (hereinafter referred to as a “charity”), the charity may register with the operator of the inventive method. Such registration will include providing of information about the charity, its goals, its charitable or other pursuits, and additional information enabling the operator of the method to verify the bonafides of the organization.

(2) From the perspective of a business enterprise (hereinafter referred to as a “business”), a business that wishes to register for the service so that a percentage of the monies it earns from sales of its products and services can be contributed to designated charities can register with the operator of the system and method. Such registration will include providing information concerning the business, and will also include a written agreement requiring the business to comply with its promises to donate a percentage of the proceeds from its sales to charities it designates. As an alternative, in accordance with the teachings of the present invention, consumers may give to the charity first and, as a result, receive an offer from a business for a special gift, a discount for future purchases of goods and/or services, or the ability to provide that benefit to a third party. Additionally, a business' involvement in the inventive system and method need not be limited to sales of products and/or services, but can also include an offer provided that may be later redeemed by the consumer. This can take the form of, for example, a coupon or a credit or a gift card.

(3) Consumers who wish to purchase products and/or services from registered businesses and to designate registered charities to receive a percentage of the proceeds from those purchases can register with the operator of the method as well. Registration permits the customers to shop with the businesses and to ensure that the designated percentage of the monies they pay the businesses are transferred to the designated charities. Registration also provides the benefit that charities are required to provide receipt documents via the operator of the system and method to the customer, which documents may be used for tax purposes to prove the charitable donations that are made.

(4) In the preferred embodiment of the present invention, computer software is employed to harness a global computer network such as the Internet to create a financial loop between businesses and consumers who share a philanthropic business with specific charities. Among the joint benefits between businesses and charities are researching and identifying charitable causes to support via product purchase designations and transporting charitable gifts of cash to specific charities via the Internet through both direct contributions from consumers and through the use of proof-of-purchase coupons that direct contributions from businesses and corporations.

(5) The inventive method facilitates providing a history of all financial transactions that occur in practicing of the method including purchases from businesses, donations to charities, and providing to consumers of receipts evidencing those transactions.

Accordingly, it is a first object of the present invention to provide a system and method for promoting business activities and charitable contributions.

It is a further object of the present invention to provide such a method in which businesses register including executing an agreement by which they promise to donate a percentage of the proceeds from their business dealings to designated charities.

It is a still further object of the present invention to provide such a method in which charitable and non-profit organizations may register to receive the monies contributed from businesses that are involved in the inventive method.

It is a yet further object of the present invention to provide such a method in which consumers may also register with the operator of the method so that they are able to (1) purchase items from the businesses, (2) ensure that a percentage of the monies they pay the businesses is contributed to the charities they have designated, and (3) provide the customers with documentation of their purchases and charitable contributions for tax purposes.

These and other objects, aspects and features of the present invention will be better understood from the following detailed description of the preferred embodiments when read in conjunction with the appended drawing figures.

### BRIEF DESCRIPTION OF THE DRAWINGS

FIG. 1 shows a flowchart of the manner of operation of the inventive method from the perspective of a charity.

FIG. 2 shows a flowchart depicting the manner of operation of the inventive method from the perspective of businesses selling goods and/or services.

FIG. 3 shows the operation of the inventive method from the perspective of the consumer.

FIG. 4 shows a flowchart detailing the accounting of funds during operation of the inventive method.

### SPECIFIC DESCRIPTION OF THE PREFERRED EMBODIMENTS

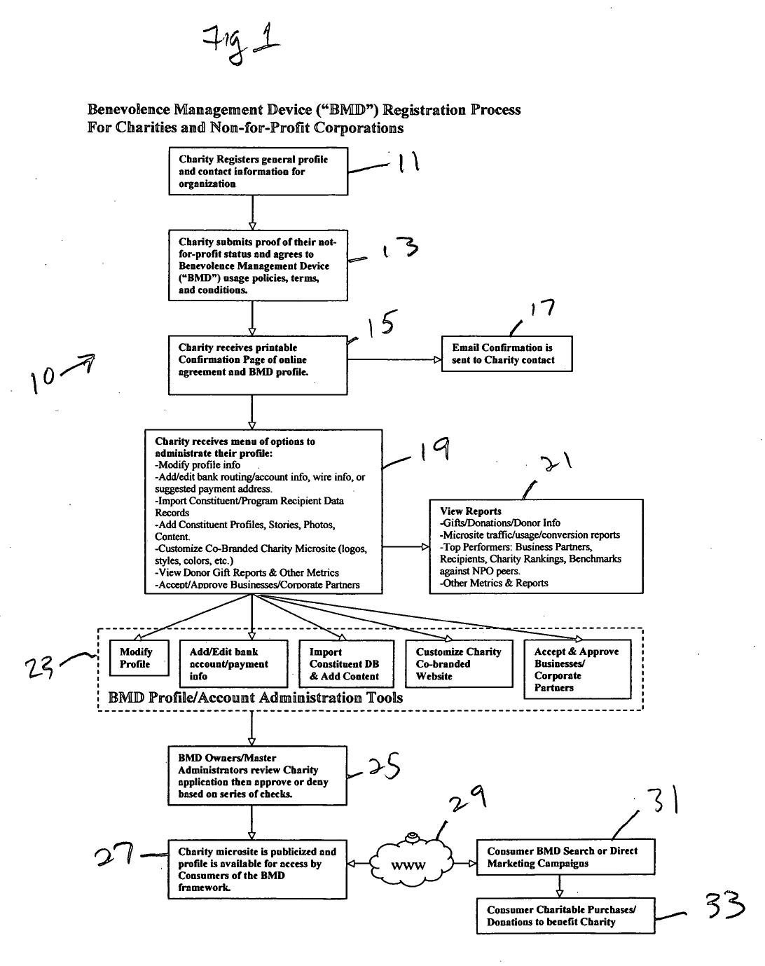

Reference is first made to FIG. 1 which depicts a flowchart generally designated by the reference numeral 10 that is intended to explain the aspects of the present invention concerning the manner of involvement of charities. As seen in the flowchart 10, first, at 11, the charity registers their general profile and contact information with the organization that is operating the inventive method (hereinafter referred to as “the organization”). Next, at 13, the charity submits proof to the organization of their not-for-profit status and agrees to the policies, terms, and conditions of the organization so that appropriate representations may be made to prospective customers.

When the charity has been accepted by the organization, confirmation is provided to the charity at 15. At the same time, at 17, a confirmation via suitable communication means such as e-mail is sent to a contact person at the charity.

Once the charity has been registered, at 19, they receive a menu of options that allow them to administratively manage their involvement with the organization in practicing the inventive system and method. Among the options available are the ability to modify profile information, the ability to edit banking information, the ability to view and store records of transactions, the ability to view donor gift reports and other metrics, and the ability to manage additions and changes to corporate partners whose business transactions will result in charitable contributions. At 21, it is explained that a number of reports may be generated from the system and method for review by the charity so that the charity can keep records of its activities involved in the inventive system and method.

The box 23 encompasses a number of boxes that describe schematically the features of the box 19 explained above concerning abilities to manage involvement in the operation. At 25, the organization has the ability to maintain monitoring of the charity to make sure that it maintains the status that permitted it to be included in operation of the system and method. If the charity falls below the pre-set minimum criteria, the organization may consider de-listing the charity.

The website of the organization publicizes the charity at 27 and with particular emphasis on publicizing the fact that purchases from corporate partners and other entities will result in contributions to the charity. Such publicity may be conducted using various venues including the Internet as schematically represented at 29, and direct marketing campaigns are represented at 31. As a result of all of these activities, at 33, consumers purchase goods and services from registered entities resulting in contributions to the charity. Of course, if desired, the charity can publicize offers of the business as well as its association with the organization. These manners of publicity may be carried out on the website of the charity and, of course, will be carried out through a microsite the organization creates for each charitable entity. Of course, the ultimate recipient of charitable giving is able to notify third parties that they are receiving benefit from a charity. This may easily be done by any suitable means of publicity including a recipient website.

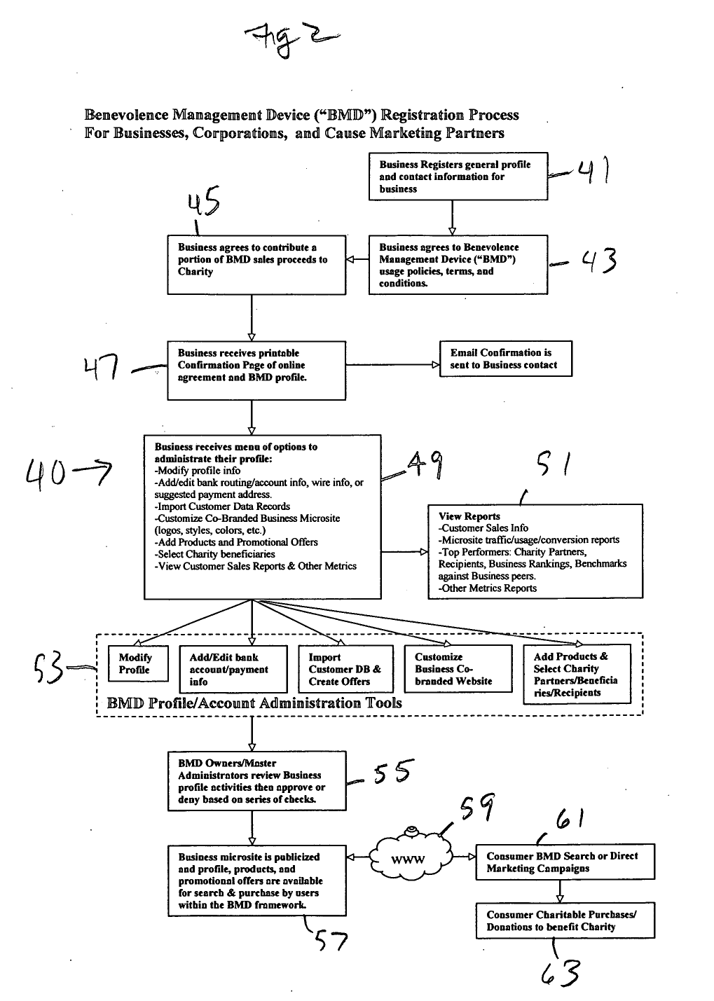

With reference, now, to FIG. 2, operation of the inventive system and method from the perspective of the business entities selling goods and services will now be described. The flowchart of FIG. 2 is generally designated by the reference numeral 40. In a similar fashion to the charity, at 41, the business, corporation, and cause marketing partners (hereinafter referred to as the business) registers their general profile with the organization including contact information for the business, both by telephone, by Internet as well as any other means such as, for example, via facsimile. At 43, the business is asked to sign an agreement as to the usage policies, terms and conditions of the organization concerning various factors including the percentage of its gross proceeds that will be contributed to charities. Pursuant to that agreement, at 45, the business agrees to that contribution scheme. A confirmation page memorializing the agreement between the organization and business is provided at 47. At 49, in a similar fashion to the box 19 in FIG. 1, the business receives a menu of options to permit them to administratively manage their profile in the scheme of the organization and the system and method. This aspect permits the business to modify their profile information, edit their banking information in terms of routing of funds to the charities they are supporting providing the ability to import customer data records. Additionally, they may use this aspect of the invention to add and delete products and services offered, create promotional offers for display, and change/modify pricing schemes. They may also use this aspect to select and establish relationships with charities and to add and subtract charities from the list they are supporting. They may also have the ability to view customer sales reports and other metrics. As shown in the box 51, the system provides the business the ability to review various reports, such as customer sales information, traffic information, usage information, performance of charity partners, and other aspects. The inventive system and method is a “two way street.” Thus, one incentive for a business to become involved is by association with popular charities and, as a result, the business' bottom line may be enhanced through increased sales. Thus, by monitoring reports concerning the amount of money each designated charity is receiving, the business can determine the effectiveness of their coupling with various charity partners. As a result of review of such information, the business may decide to delete one or more charities from their designated list of charities and/or add others. At the same time, if desired, the organization can provide each business with information concerning all of the charities involved in the system and method so that each business can determine the success other businesses are having with various charities. In this way, it is possible for a business to decide to add other charities that seem to be driving additional revenue to other businesses.

The administrative tasks undertaken with reference to the box 49 are also shown in the box 53 in separate form. At 55, the organization monitors the activities of the business within the operation of the system and method on a regular basis to ensure that the business is maintaining its operations within the minimum guidelines of the organization for quality, reputation, charitable donations, and any other desired criteria. If a business falls below the minimum standards, it may be placed on a probationary status or, if sufficiently egregious, removed from the system.

So long as the business maintains its good standing with the organization, the business is publicized at 57 by having its profile, products and promotional offers as well as pricing and charitable partners publicized on a website as schematically represented by the “WWW” box 59. Other means of publicity may be employed as at 61 such as direct marketing campaigns. The box 63 is the same as the box 33 and represents purchases by consumers from the business resulting in contributions to one or more charities.

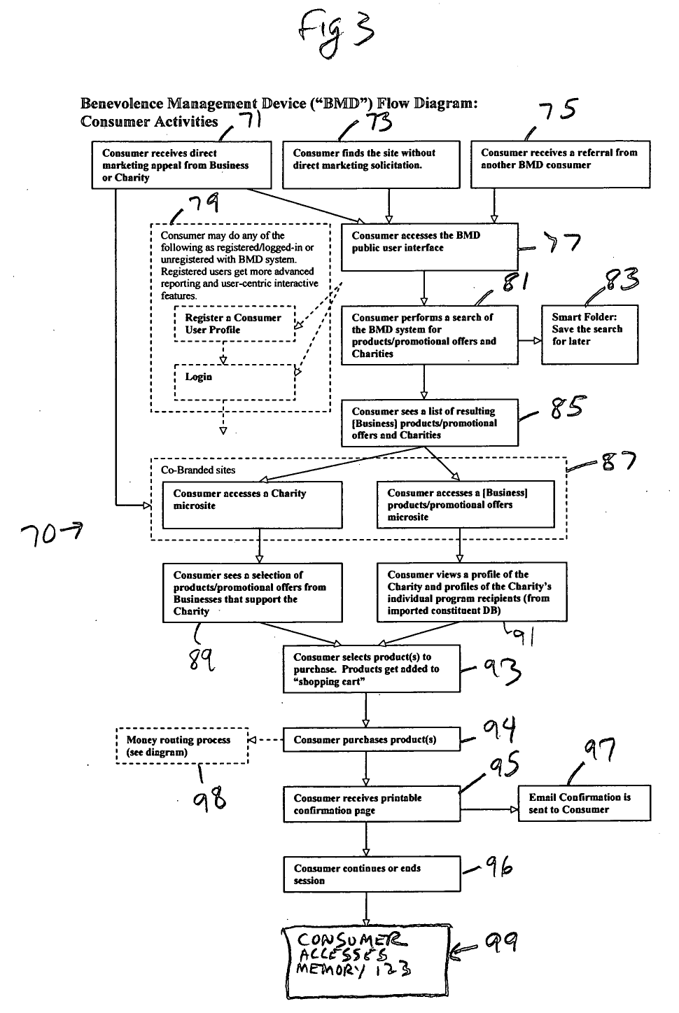

With reference to FIG. 3, a flowchart generally designated by the reference numeral 70 explains the operation of the inventive system and method from the perspective of the consumer who is to be purchasing goods and/or services from a business resulting in contributions to one or more charities. As shown in FIG. 3, there are several ways by which a consumer can become aware of the system and make use of it to benefit businesses and charities. The consumer may receive a direct marketing appeal 71 from a business or charity; the consumer may find the site on their own 73 without direct marketing solicitation; the consumer might receive a referral 75 from another consumer. Other ways by which the consumer might become aware of the organization and the system and method and take advantage of its attributes may suitably be employed.

By whatever way the consumer finds out about the system and method, it is accessed at 77 through a public user interface that may, if desired, be the consumer's own personal computer. It is not necessary that a consumer register with the organization, however, the organization will typically provide advanced features for a consumer that does register. This is represented at 79. Whether or not the consumer has registered, the consumer may perform a search at 81 for charities he or she wishes to benefit and businesses he or she wishes to patronize. If desired, a folder may be provided to the consumer at 83 to save searches for later use. During the course of a search, a display of potential charities and businesses may be provided at 85. At 87, it is explained that micro-sites are provided for charities and businesses and the consumer may access those micro-sites to review offerings, both of products and/or services to purchase and of charities to benefit. The micro-sites for charities may provide all manner of information about them and the micro-sites may, if desired, also provide information informing the consumer as to the percentage of the money they pay the business that will be contributed to the charity. These aspects are depicted in the boxes 89 and 91.

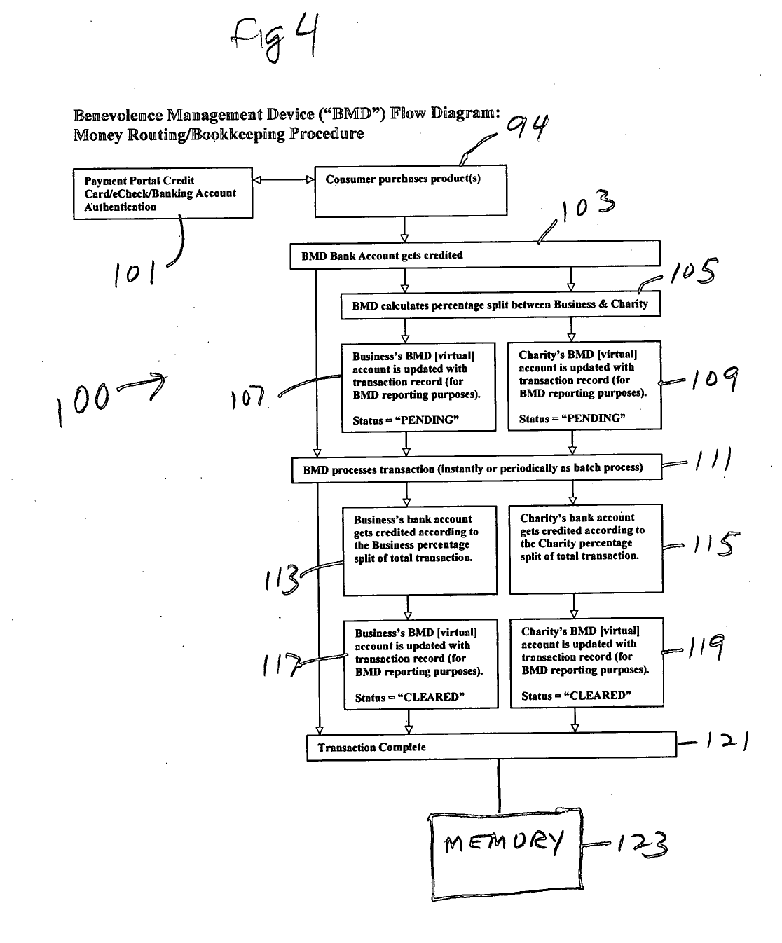

Once the consumer has been suitably educated concerning the businesses and charities involved with the organization in the system and method, the consumer may select products at 93 that the consumer wishes to purchase. As typically happens in Internet marketing, the consumer may purchase products at 94, receive a printed or printable confirmation page at 95, and continue their shopping at 96. When a printable confirmation page is provided at 95, if desired, the consumer may also receive an e-mail at 97 confirming a transaction. The box identified by the reference numeral 98 shows the interconnection between the flowchart 70 and the flowchart 100 depicted in FIG. 4.

With reference to FIG. 4, the box 94 from FIG. 3 is also shown in the flowchart 100. Payment is authenticated at 101 and a bank account set up by the organization is credited with monies paid by the consumer at 103. At 105, the split between the business and charity is calculated.

Subsequently, the business' account with the organization is updated at 107, and the charity's account is updated at 109. The transaction is processed at 111 with the business' bank account being credited at 113 in accordance with the agreed upon split between the business and the charity. Similarly, at 115, the charity's split of the monies received is deposited. At 117 and 119, the accounts of the business and charity, respectively, are updated as a result of the transaction. At 121, the transaction is complete, and information concerning the transaction is transmitted to a memory 123. The memory 123 may be accessed by the charity with reference to the box 21 at FIG. 1, by the business with reference to the box 51 in FIG. 2, and by the consumer with reference to the box 99 in FIG. 3. The consumer may access the memory to facilitate printing out of receipts evidencing charitable contributions and receipts from businesses evidencing purchases, particularly, where the consumer is purchasing items that may be tax deductible for whatever reason cognizable under the Internal Revenue Service Code.

The inventive system and method may be used in several different ways to assist businesses in increasing sales while at the same time assisting charities through consumer purchases that result in charitable contributions.
a. Consumers are able to use the system to track, manage, and archive all philanthropic gifts and coordinated charitable gifts made through purchases of products and/or services.
b. Consumers are able to use archived donation history and purchase records for documentation for income tax deduction documentation for the federal Internal Revenue Service and state reporting agencies.
c. Consumers are able to identify companies that support their communities through philanthropic coupon programs and direct financial support to charities.
d. Businesses are able to develop relationships with charities that will promote their business products and/or services to the charities' donor and support networks to increase sales.
e. Businesses are able to develop a database of consumers who make purchases of the business services/productions because of the business with a specific charity.
f. Businesses are able to keep archived donation history and purchase records for documentation for income tax deduction documentation for the federal Internal Revenue Service and state reporting agencies.
g. Charities are able to build a database of consumers who share a business with their cause, as well as cross reference the purchase history of those same consumers based upon specific business products and/or services purchased.
h. Charities are able to use the system to track, manage, and archive all philanthropic gifts and coordinated charitable gifts made through product purchases.
i. Charities are able to keep archived donation history and purchase records for documentation for income tax deduction documentation for the federal Internal Revenue Service and state reporting agencies.

Examples of charities and non-profit organizations that can benefit in accordance with the teachings of the present invention include the following:
1. An athlete or student in need of funding for books, equipment, tuition and so on.
2. A missionary in need of funding in order to continue their work.
3. A politician in need of funding to run for office.
4. A family in need of funding due to a tragedy in their family, including but not limited to cancer.
5. A recognized charity or not-for-profit organization or event.
6. A charity can also be a supporting organization, such as an educational facility, school, church, and not-for-profit organization can also be the custodian for the income received on behalf of a student's tuition, a missionary's income, politician's fundraising, Olympic athletes, etc.

The figures show a manner of purchase that includes use of the global computer network known as the Internet. Another way the system can operate includes access to a computer so that a consumer can print coupons to be redeemed at the physical location of a business. When such a coupon is redeemed, in accordance with the teachings of the present invention, the agreed upon percentage of the gross receipts from the transaction is given to the charity.

The present invention provides significant benefits as follows:

a. It creates a cause agent: The Consumer-Business-Charity Business Benevolence Management Device can be proactive and initiate a search for a cause to aid on a one-time basis, or save such a search profile as an agent that will provide them with an alert when such a cause has been found.
i. For example: A consumer may desire to find a local charity in need of funding within a 5 mile radius of the consumer's home town. A cause que. Upon a need being entered by a charity or organization that meets the criteria, cause agent alerts the consumer/donors. This system will also allow a specific dollar amount to be disbursed upon the confirmation of such a qualification.

b. It provides management tools: allows for scheduling and management and records and reports of gifts, beneficiaries, organizations, one time, recurring, or even recurring until a specific amount of the gift is met, or the goal has been met, whichever is sooner.

c. It provides one location: for businesses, consumers, and charities to support multiple charities and their causes.

d. It provides giving history for all causes: All cash and non-cash contributions are available at all times.

e. It provides rewards and/or discounts for consumers based on all of their giving—based on a quantifiable system. In this way, they are allowed to still benefit from a product and/or service as they do in traditional off-line fundraising.

f. It provides incentives: from providing businesses with a business to charitable organizations that desire to reach the consumer/donors in a non-obtrusive way.

g. It protects anonymity: The consumer only reveals their identity at a time of their choosing, if ever. If desired, the identity of the recipient of the money or other benefit is also maintained confidential.

h. It may develop a relationship: With the permission of the consumer, either with or with no incentive, or by a level-based incentive, the consumer will be able to communicate with the charity in ways including, but not limited to web mail and other methods that can be controlled within the system.

i. It allows complete control of solicitations.

j. It provides contact management: consumer and business can be manually or automatically added to the charities' “address book.”

k. It provides gift management: based on all gifts.

l. It protects anonymity: The consumer may choose to make their identity known to private charities, but when displaying for public business solicitation, the identity of the consumer is protected (especially in the case of children).

m. It provides ability to set levels of consumers based upon factors such as gift amount, frequency. It may also provide incentives to consumers, such as 5 free auction items, or only allowing a specific level of consumer to compete for a specific item

n. It provides ability to develop a closer relationship with consumers through systems including but not limited to web mail.

o. It provides ability for auction of items related to cause: For example, a dancer may decide to auction ballet shoes worn in a specific show.

p. It provides immediate funding to the charitable organization to assist in cash flow forecasting.

q. It provides the ability to tap into potentially all consumers/donors.

r. It provides the ability to create automated consumer offers based upon cause, giving amount or other factors.

s. It provides request-based offers that can be fulfilled based upon consumer profiles:
i. For example, as a consumer, I'm interested in eating at McDonald's for lunch. Because McDonald's is in the system, I am able to go to an area that would allow me to make an anonymous (or not) request from McDonald's. The system would match my profile against McDonald's criteria and either allow me to select from offers based on my profile, or make a specific request and receive a discount. This is to say, if I'm hungry for a Big Mac, I'd rather have 10 cents off of a Big Mac instead of 50 cents off of a salad; all based upon how much money I have donated to McDonald's supported charities. OR, in the case of Meineke, why should they spend time and money appealing to me for a muffler, when I really need brakes. I request the brake discount from them rather than my getting brakes done by someone who offered me the timely discount. Again, this is all based upon how much money I have donated to Meineke's supported charities.

t. Businesses could become a bit like “Santa” in that they could take request lists from consumers/donors and beneficiaries and provide incentives to purchase their product for a discount, in bulk (a few friends get together), or to donate unsold stock and receive a tax deduction.

u. Unlike all other current solutions that end with the cause or the charity, this system closes the gap by including roles of the business and consumers/donors.
i. For example:
   1. McDonald's supports the Olympics. I give to an Olympic athlete. The athlete offers “points” for my gift based on my points, or because they are a sponsor of the Olympics. McDonald's offers me an incentive (maybe 5 e-coupons for menu items for my friends and my choice, or credits on a business card . . . ). My friends and I travel to McDonald's, use our coupons, spend our money, (McDonald's tracks the coupons and spending). McDonald's uses a portion of our money to support the Olympics.

As such, an invention has been disclosed in terms of preferred embodiments thereof which fulfill each and every one of the objects of the invention as set forth hereinabove, and provide a new and useful method for promoting business activities and charitable contributions of great novelty and utility.

Of course, various changes, modifications and alterations in the teachings of the present invention may be contemplated by those skilled in the art without departing from the intended spirit and scope thereof.

As such, it is intended that the present invention only be limited by the terms of the appended claims.

1. A method of promoting business activities and charitable contributions including the steps of:
a) providing a computer having a memory;
b) registering at least one charity in said memory, said charity being desirous of receiving charitable contributions;
c) registering at least one business in said memory, said business agreeing to contribute a percentage of financial proceeds from business activities to said charity;
d) at least one consumer accessing said memory, said accessing step including the steps of:
i) viewing information concerning said charity;
ii) viewing products and/or services provided by said business and for which, when a payment is tendered by said consumer, said percentage of financial proceeds is contributed to said charity;
e) said consumer purchasing at least one offer, product or service from said business;
f) said percentage being contributed to said charity.

2. The method of claim 1, wherein said registering at least one charity step comprises registering a plurality of charities.

3. The method of claim 1, wherein said step of registering at least one business comprises registering a plurality of businesses.

4. The method of claim 1, wherein said registering at least one charity step includes the step of causing said at least one charity to sign an agreement with an organizer of said method setting forth terms and conditions by which said at least one charity shall receive charitable contributions.

5. The method of claim 4, wherein said registering at least one business step includes the step of causing said at least one business to sign an agreement with said organizer setting forth terms and conditions by which said at least one business shall be the subject of promotional activities by said organizer and by which said business shall contribute an agreed upon percentage of financial proceeds from business activities to said at least one charity.

6. The method of claim 1, wherein said viewing information step includes the step of obtaining information concerning charitable purposes of said charity, balance sheets concerning said charity, and percentages of contributions used for (a) administrative expenses and (b) charitable purposes.

7. The method of claim 1, wherein said viewing products and/or services step includes the steps of searching for products and/or services provided by said business and obtaining information concerning said products and/or services.

8. The method of claim 1, conducted on a global computer network.

9. The method of claim 8, wherein said registering at least one charity step is conducted on said global computer network.

10. The method of claim 9, wherein said registering at least one business step is conducted on said global computer network.

11. The method of claim 10, wherein said consumer accessing step is conducted on said global computer network.

12. The method of claim 11, wherein said consumer accessing step is conducted using a personal computer connected to said global computer network.

13. The method of claim 8, further including the step of interconnecting said computer and memory to a banking institution via said global computer network, proceeds from said consumer purchasing step being paid to said business via said banking institution after said percentage contributed to said charity is deducted.

14. The method of claim 13, wherein said percentage contributed to said charity is paid to said charity by said banking institution via said global computer network.

15. A method of promoting business activities and charitable contributions including the steps of:
a) providing a computer having a memory;
b) connecting said computer and memory to a global computer network;
c) registering a plurality of charities in said memory via said global computer network, said charities being desirous of receiving charitable contributions;
d) registering a plurality of businesses in said memory via said global computer network, each of said businesses agreeing to contribute a percentage of financial proceeds from business activities to one or more of said charities;
e) at least one consumer accessing said memory via said global computer network, said accessing step including the steps of:
a. viewing information concerning one or more of said charities via said global computer network;
b. viewing products and/or services provided by one or more of said businesses via said global computer network and for which, when a payment is tendered by said consumer, said percentage of financial proceeds is contributed to one or more of said charities;
f) said consumer purchasing at least one product or service from at least one of said businesses;
g) said percentage being contributed to at least one of said charities.

16. The method of claim 15, wherein said registering a plurality of charities step includes the step, with respect to each charity, of causing each charity to sign an agreement with an organizer of said method setting forth terms and conditions by which said charity shall receive charitable contributions.

17. The method of claim 16, wherein said registering a plurality of businesses step includes the step, with respect to each business, of causing each business to sign an agreement with said organizer setting forth terms and conditions by which said business shall be the subject of promotional activities by said organizer and by which said business shall contribute an agreed upon percentage of financial proceeds from business activities to one or more of said charities.

18. The method of claim 15, wherein said viewing information step includes the step of obtaining information concerning charitable purposes of at least one of said charities, balance sheets concerning said at least one of said charities, and percentages of contributions used for (a) administrative expenses and (b) charitable purposes.

19. The method of claim 15, wherein said viewing products and/or services step includes the steps of searching for products and/or services provided by said businesses and obtaining information concerning said products and/or services.

20. The method of claim 15, further including the step of interconnecting said computer and memory to a banking institution via said global computer network, proceeds from said consumer purchasing step being paid to said businesses via said banking institution after said percentage contributed to said charities is deducted.
